(19) United States
(12) Patent Application Publication
(10) Pub. No.: US 2026/0047575 A1
(43) Pub. Date: Feb. 19, 2026

(54) NOVEL FORMULATION SYSTEMS OF TRIKETONE HERBICIDE

(71) Applicant: ADAMA AGAN LTD., Ashdod (IL)

(72) Inventors: Lior ZISERMAN, Holon (IL); Yana NIRENBERG, Modiin (IL); Victoria ABRAMOV, Ashdod (IL)

(73) Assignee: ADAMA AGAN LTD., Ashdod (IL)

(21) Appl. No.: 19/129,800

(22) PCT Filed: Nov. 13, 2023
(86) PCT No.: PCT/IL2023/051167

§ 371 Date: May 14, 2025

Related U.S. Application Data
(60) Provisional application No. 63/424,965, filed on Nov. 14, 2022.

(51) Int. Cl. A01N 41/10; A01N 25/04; A01N 25/30; A01N 25/32; A01N 43/10; A01N 47/38; A01P 13/02

(52) U.S. Cl. CPC A01N 41/10; A01N 25/04; A01N 25/30; A01N 25/32; A01N 43/10; A01N 47/38; A01P 13/02

(57) ABSTRACT

The present invention relates to stable and efficient non-aqueous agrochemical formulations comprising a Triketone herbicide, at least one additional herbicide; one or more vegetable oils or derivatives thereof, a surfactant system comprising a mixture comprising an ionic phosphated Tristyrylphenol alkoxylate and a non-ionic Tristyrylphenol alkoxylate; and also it relates to methods for controlling undesired plant species by applying the said environment-friendly formulation after dilution with water to the plant species.

### RELATED APPLICATION/S

This application claims benefits of U.S. Provisional Application No. 63/424,965 filed on Nov. 14, 2022; the entire content of which is hereby incorporated by reference herein. Throughout this application, various publications are cited. Disclosures of the documents and publications referred to herein are hereby incorporated in their entireties by references into this application.

### FIELD OF INVENTION

The present invention relates to stable and efficient non-aqueous agrochemical formulations comprising a Triketone herbicide; at least one additional herbicide; one or more vegetable oils or derivatives thereof, a surfactant system comprising a mixture comprising an ionic phosphated Tristyrylphenol alkoxylate and a non-ionic Tristyrylphenol alkoxylate; and also relates to methods for controlling undesired plant species by applying the said environment-friendly formulation after dilution with water to the plant species, by way of increasing chemical stability as well as dispersion stability of the herbicides within the formulation, thereby enhancing efficiency.

### BACKGROUND OF INVENTION

Triketone herbicides were always found to be effective on a wide range of weed species and to have both pre-emergence and post-emergence activity. Triketone herbicides control a wide range of broad-leaved weeds that compete with maize and also can suppress some annual grass weeds that may be present in the crop. They achieve this selectivity and minimize the damage to the crop owing to its greater potency on the target enzyme found in dicotyledons than monocotyledons and because maize can metabolise the compound in the dione-containing ring.

Triketone herbicides which inhibit the enzyme 4-hydroxyphenylpyruvate dioxygenase (HPPD) possess a broad spectrum of activity on commercially important grassy and broadleaf weeds including Abutilon theophrasti, Amaranthus powellii, Amaranthus retroflexus, Chenopodium album, Datura stramonium, Digitaria sanguinalis, Lamium purpureum, Polygonum persicaria, Rumex crispus, Senecio vulgaris, Solanum nigrum, Stellaria media and Xanthium strumarium. Furthermore, these herbicides can be applied to soil so that emerging weeds take it up and are controlled. Alternatively, spraying after weeds are already present in the crop will also lead to control. This combination of properties has meant that Triketone herbicides achieved widespread use. Some of the widely used Triketone herbicides are Mesotrione, Sulcotrione, and Tembotrione.

Despite the benefits derived from the use of herbicides in general, and the Triketone herbicides in particular, in agriculture such as protection of crops and improved productivity, it is always a challenge to make judicious spreading and application of herbicide formulations which give chemical stability of the herbicide as well as ensuring its dispersion stability while diluting the formulation with water before applying to the field. Triketone compounds are particularly considered to be less stable in the ecosystems in comparison with other herbicides. The chemical stability as well as the dispersion stability of a Triketone herbicide are observed to be matters of great concern when one or more active herbicides are attempted to be accommodated in a formulation. These makes the task of making suitable stable formulations of a Triketone compound in combination of other compatible herbicides more difficult. The compatible partners for Triketone compounds in herbicidal formulations in the prior art are inter alia a Chloroacetamide and a Sulfonylamino-carbonyl triazolinone.

Furthermore, there still exists serious concern over use of regular organic solvents in both aqueous and non-aqueous agricultural formulations due to their cost, flammability, and contribution to environmental pollution. Moreover, a Triketone compound, in combination with other compatible herbicides have further challenges with regard to chemical stability in an aqueous formulation, which makes the use of a suitable solvent mandatory to develop a stable formulation of Triketone herbicide.

There is therefore a need of an efficient herbicide formulation of a Triketone compound which typically broaden spectrum of control in an environmentally friendly medium without compromising chemical stability of the herbicide with enhancement of dispersion stability after dilution with water. Although many formulations of Triketone herbicides have been studied, the challenge remains to prepare a stable and efficient herbicide formulation system of one or more Triketone herbicides which provide good chemical stability and dispersion stability. In the absence of efficient choice of co-formulants in the formulation, the application of formulation is said to be not well pronounced.

No prior art has ever addressed the problem of non-aqueous formulations of one or more Triketone compounds, either alone or in combination with other compatible herbicides, of chemical stability as well as dispersion stability of the Triketone herbicide in water in efficient way. The meticulous choice of suitable solvents, co-formulants and the surfactant system in the formulation may result in surprising outcome to the efficiency of the said formulation.

In light of the above, there is endeavor in the present invention for novel stable and efficient non-aqueous formulations of one or more Triketone compounds; suitable solvents and surfactant system, for increasing the desirable chemical stability as well as dispersion stability of the active substances and better penetration of the active substances on the target surface of plant, thereby enhancing overall efficiency of the formulation.

### SUMMARY OF THE PRESENT SUBJECT MATTER

We have reasonably addressed the challenges as described above as a whole or in part by arriving at a novel stable non-aqueous agrochemical formulation with suitable coformulants, as defined below.

The present invention relates to a stable non-aqueous agrochemical formulation comprising (a) an effective amount of a Triketone herbicide; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention also relates to a stable non-aqueous agrochemical formulation comprising (a) an effective amount of a Triketone herbicide, wherein the Triketone herbicide is selected from a group comprising Mesotrione, Sulcotrione, and Tembotrione; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention specifically relates to a stable non-aqueous agrochemical formulation comprising (a) an effective amount of Mesotrione; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention further relates to a stable non-aqueous agrochemical formulation comprising (a) an effective amount of a Triketone herbicide; (b) an effective amount of at least one additional herbicide, wherein the additional herbicide is selected from a group comprising a Chloroacetamide and a Sulfonylamino-carbonyl triazolinone compound; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention relates to a stable non-aqueous agrochemical formulation comprising (a) an effective amount of a Triketone herbicide; (b) an effective amount of at least one additional herbicide, wherein the additional herbicide is a Chloroacetamide compound, which is Dimethanamid; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention relates to a stable non-aqueous agrochemical formulation comprising (a) an effective amount of a Triketone herbicide; (b) an effective amount of at least one additional herbicide, wherein the additional herbicide is a Sulfonylamino-carbonyl triazolinone compound, which is Thiencarbazone methyl; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention specifically relates to a stable non-aqueous agrochemical formulation comprising (a) an effective amount of Mesotrione; (b) an effective amount of Dimethanamid; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention also specifically relates to a stable non-aqueous agrochemical formulation comprising (a) an effective amount of Mesotrione; (b) an effective amount of Thiencarbazone methyl; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

The present invention specifically relates to a stable non-aqueous agrochemical formulation comprising (a) an effective amount of Mesotrione; (b) an effective amount of Dimethanamid; (c) an effective amount of one or more vegetable oils or derivatives thereof, as solvents; and (d) an effective amount of a surfactant system comprising a mixture comprising Soprophor 3 D33 and Soprophor BSU.

The present invention also specifically relates to a stable non-aqueous agrochemical formulation comprising (a) an effective amount of Mesotrione; (b) an effective amount of Thiencarbazone methyl; (c) an effective amount of one or more vegetable oils or derivatives thereof, as solvents; and (d) an effective amount of a surfactant system comprising a mixture comprising Soprophor 3 D33 and Soprophor BSU.

The present invention further relates to a stable non-aqueous agrochemical formulation comprising (a) an effective amount of a Triketone herbicide; (b) an effective amount of at least one additional herbicide; (c) an effective amount of one or more vegetable oils as solvents are selected from a group comprising rapeseed oil, soybean oil, olive oil, castor oil, sunflower seed oil, coconut oil, corn oil, cottonseed oil, linseed oil, palm oil, peanut oil, safflower oil, sesame oil, tung oil kapok oil, papaya oil, camellia oil, rice bran oil or derivatives thereof; and (d) an effective amount of a surfactant system comprising a mixture comprising an ionic phosphated Tristyrylphenol alkoxylate and a non-ionic Tristyrylphenol alkoxylate.

The present invention further relates to a stable non-aqueous agrochemical formulation comprising (a) an effective amount of a Triketone herbicide; (b) an effective amount of at least one additional herbicide; (c) an effective amount of the vegetable oil is rapeseed oil, which is a refined canola oil; and (d) an effective amount of a surfactant system comprising a mixture comprising an ionic phosphated Tristyrylphenol alkoxylate and a non-ionic Tristyrylphenol alkoxylate.

The present invention also provides a method of treating a plant against undesired vegetation comprising applying non-aqueous agrochemical formulation disclosed herein, after dilution with water, to the target sites of the field, so as to treat the plant against undesired vegetation.

The present invention further provides use of the non-aqueous agrochemical formulation disclosed herein for controlling grassy and broadleaf weeds such as Digitaria ssp., Echinochloa ssp., Setaria ssp., Eriochloa ssp., Sorghum ssp., Lolium ssp., Panicum ssp, Poa ssp, Agropyron ssp, Amaranthus ssp., Abutilon ssp., Ambrosia ssp., Chenopodium SSP., Datura Ssp., Mercurialis ssp., Fallopia ssp., Portulaca ssp., Solanum ssp., Stellaria ssp., Thlaspi ssp, Viola ssp., Geranium ssp, Matricaria ssp, Polygonum ssp, Cirsium ssp, Xanthium ssp and Hibscus ssp on fields.

The present invention also provides a process for the preparation of the non-aqueous agrochemical formulation disclosed herein from individual component parts.

The present invention further provides a method of controlling undesired vegetation comprising applying to the locus the non-aqueous agrochemical formulation disclosed herein. The present invention also provides a method for controlling grassy and broadleaf weeds comprising diluting with water non-aqueous agrochemical formulation disclosed herein, and applying the formulation to the locus of the plant.

The present invention provides a method of controlling undesired vegetation comprising applying to the locus the stable non-aqueous agrochemical formulation comprising (a) an effective amount of a Triketone herbicide; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate in a ratio of 1:1 to 10:1.

The present invention also provides a method of controlling undesired vegetation comprising applying to the locus the stable non-aqueous agrochemical formulation comprising (a) an effective amount of Mesotrione; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate in a ratio of 1:1 to 10:1.

### DETAILED DESCRIPTION OF THE PRESENT SUBJECT MATTER

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

Certain exemplary embodiments are described to provide an overall understanding of the principles of the invention disclosed herein. It is assumed that those skilled in the art will understand that the inventive features and methods specifically described herein and illustrated in the experimental section are non-limiting exemplary embodiments and that the scope of the present invention is defined solely by the claims. The features illustrated or described in one exemplary embodiment may be combined with the features of other embodiments. Such modifications and variations are intended to be included within the scope of the present invention.

Reference will now be made in detail to embodiments, which are illustrated in the subsequent paragraphs, wherein reference numerals refer to like elements throughout. In this regard, the present embodiments may have different forms and should not be construed as being limited to the descriptions set forth herein. Accordingly, the embodiments are merely described below to explain aspects of the present disclosure.

As used herein, the term “pesticide” in general broadly refers to an agent that can be used to control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “system” means but is not limited to an assemblage of active ingredients and/or acceptable coformulants for application either by simultaneous, contemporaneous and/or succession application. It also means a combination in any time of application of the individual components e.g. succession and/or in any physical form, e.g. blend, solution, suspension, dispersion, emulsion, alloy, or the like. “System” also may refer to combining and applying the active components and acceptable coformulants as one composition and/or formulating each of the active component in the mixture or combination as separated compositions and application at the same time or in separated applications at the same time or different times.

The admixture or individual components may be in any physical form, e.g. blend, solution, suspension, dispersion, emulsion, alloy, or the like.

As used herein, the term “agrochemically effective amount” refers to an amount of the active component that is commercially recommended for use to control weed. The commercially recommended amount for each active component, often specified as application rates of the commercial formulation, may be found on the label accompanying the commercial formulation. The commercially recommended application rates of the commercial formulation may vary depending on factors such as the plant species and the weeds to be controlled.

As used herein, the term “more effective” includes, but is not limited to, increasing efficacy of weed control, prolonging protection and reducing the amount of time needed to achieve a given level of weed control, prolonging the duration of protection against weeds after application and extending the protection period against weeds and/or reducing the amount of time needed to achieve a level of weed control compared to the herbicide formulation without suitable coformulants therein.

As used herein, the term “effective” when used in connection with any mixture or formulation system may be but is not limited to increase in controlling weeds, decrease time for effective controlling weeds, decrease the amount of the herbicide(s) which is required for effective controlling weed, extend the controlling effect of the individual herbicide active in the mixture in terms of type of crop and weed, prolong the time of controlling effect of the formulation. In particular, the term “effective” may refer to, increasing efficacy of weed control in untreated plant area, reducing the amount of time needed to achieve a given level of weed control, extending the protection period against weed and/or reducing the amount of time needed to achieve a level of weed control.

As used herein, the term “effective amount” refers to an amount of the individual components in an agrochemical formulation system or of the mixture which is critical for manufacturing effective formulation as well as for controlling harmful weed on crop plants and does not cause any significant damage to the treated crop plants.

As used herein, the term “agriculturally acceptable carrier” means carriers which are known and accepted in the art for the formation of compositions for agricultural or horticultural use.

As used herein, the term “coformulants” is defined as any substance that itself is not an active ingredient but is added to the composition or formulation such as additives, thickening agent, sticking agents, wetting agent, surfactants, anti-oxidation agent, anti-foaming agents and thickeners.

As used herein the term “plant” or “crop” includes reference to agricultural crops including field crops (soybean, maize, wheat, rice, etc.), vegetable crops (potatoes, cabbages, etc.), fruits (peach, etc.), semi-perennial crops (sugarcane) and perennial crops (coffee and guava).

As used herein the term “plant” or “crop” includes reference to whole plants, plant organs (e.g. leaves, stems, twigs, roots, trunks, limbs, shoots, fruits etc.), plant cells, seedling or plant seeds. This term also encompasses plant crops such as fruits.

The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts, basal shoots, stolons, and buds and other parts of plants, including seedlings and young plants, which are to be transplanted after germination, rooting or after emergence from soil or any other kind of substrate, be it artificial or natural.

As used herein, the term “locus” includes not only areas where weeds may already be shown, but also areas where undesired vegetation have yet to show and also area under cultivation. Locus include but is not limited to soil and other plant growth medium.

As used herein, the terms “control” or “controlling” or “treating” refers but is not limited to preventing weeds, protecting plants from weeds, delaying the onset of undesired vegetation, and combating weeds.

The term “applying” or “application”, as used herein, refers but is not limited to applying the compounds and compositions of the invention to the plant, to a site of weeds, to a potential site of weeds, which may require protection from undesired vegetation, or the environment around the habitat or potential habitat of the weeds. The application may be by methods described in the present invention such as by spraying, dipping, etc.

Throughout the application, descriptions of various embodiments the term “comprising” is used; however, it will be understood by one of skill in the art, that in some specific instances, an embodiment can alternatively be described using the language “consisting essentially of” or “consisting of.” The term “a” or “an” as used herein includes the singular and the plural, unless specifically stated otherwise. Therefore, the terms “a,” “an”, “one or more” or “at least one” can be used interchangeably in this application.

Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

As used herein, the term “and/or” includes any and all combinations of one or more of the associated listed items. Expressions such as “at least one of,” when preceding a list of elements, modify the entire list of elements and do not modify the individual elements of the list.

For purposes of better understanding the present teachings and in no way limiting the scope of the teachings, each numerical parameter should be construed in light of the number of reported significant digits and by applying ordinary rounding techniques. In this regard, used of the term “about” herein specifically includes ±10% from the indicated values in the range. In addition, the endpoints of all ranges directed to the same component or property herein are inclusive of the endpoints, are independently combinable, and include all intermediate points and ranges.

### Herbicide Formulations

The formulation of the present invention comprises a non-aqueous solvent system. The term “non-aqueous solvent system” means that one or more solvents other than water are used as the liquid carrier in the liquid composition. This does not mean to say that the solvent system must necessarily be completely free of water. Trace amounts of water may be present in the components that are used to prepare the non-aqueous solvent system. For instance, trace amounts of water may be introduced into the solvent system by organic solvents, surfactants or salts that are used to prepare the liquid herbicidal composition. While the term “non-aqueous solvent system” can be taken to mean that the liquid composition comprises water in an amount of 5 wt. % or less of the composition, preferably 3 wt. % or less, more preferably 2 wt. % and most preferably 1 wt. % or less.

There is always a challenge to formulate an herbicide formulation comprising a Triketone herbicide and at least one additional herbicide having a suitable surfactant system, for increasing the desirable chemical stability as well as dispersion stability, resulting enhancement of overall efficiency of the formulation.

In this endeavor, the inventors have attempted several options to make a stable and efficient formulation system by judiciously choosing conglomerate of coformulants which may result in creating a conducive environment for the active ingredients to have desirable chemical stability as well as dispersion stability in the formulation. Several combinations of inert components or coformulants were tried, and eventually the desired results were arrived at.

After several experimentations, it is surprisingly found that in the non-aqueous formulation, the chemical stability of a Triketone herbicide (e.g. Mesotrione) and their performance (e.g. dispersibility in water) was significantly improved by incorporation of an acidic surfactant such as Soprophor 3D33 (ionic phosphated Tristyrylphenol alkoxylate) together with a non-ionic Tristyrylphenol ethoxylates (e.g. Soprophor BSU).

In most cases in the prior arts, the non-aqueous formulations such as Oil Dispersion (OD) formulations contain surfactants such as fatty alcohol ethoxylate alkyl ether, calcium dodecylbenzenesulphonates, Docusate sodium, and Castor oil, ethoxylated, oleate based (e.g. Alkamuls VO 2003). It is observed during the course of experimentations that these classic methodologies did not work in maintaining the disposition stability as well as chemical stability of the formulations. However, the meticulous use of these acidic surfactant such as ionic phosphated Tristyrylphenol alkoxylate together with a non-ionic Tristyrylphenol ethoxylates helping in disposition stability as well as chemical stability in the invented formulation is very unusual.

It has also been found that the ionic phosphated Tristyrylphenol alkoxylate stabilizes the emulsification of the active substances within the formulation when diluted in tank mix with water. The non-ionic Tristyrylphenol ethoxylates are also found to be mandatory to prevent appearance of sticky sediments after the dilution with water. Moreover, this also allows to use vegetable oils, with their adjutancy power benefits, as the main solvent in formulations containing a Triketone herbicide like Mesotrione.

In an embodiment, the present invention provides a stable non-aqueous agrochemical formulation comprising (a) an effective amount of a Triketone herbicide; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In another embodiment, the present invention provides a stable non-aqueous agrochemical formulation comprising (a) an effective amount of a Triketone herbicide, wherein the Triketone herbicide is selected from a group comprising Mesotrione, Sulcotrione, and Tembotrione; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In a further embodiment, the present invention provides a stable non-aqueous agrochemical formulation comprising (a) an effective amount of Mesotrione; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In another embodiment, the present invention provides a stable non-aqueous agrochemical formulation comprising (a) an effective amount of a Triketone herbicide; (b) an effective amount of at least one additional herbicide, wherein the additional herbicide is selected from a group comprising a Chloroacetamide and a Sulfonylamino-carbonyl triazolinone compound; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In an embodiment, the present invention provides a stable non-aqueous agrochemical formulation comprising (a) an effective amount of a Triketone herbicide; (b) an effective amount of at least one additional herbicide, wherein the additional herbicide is a Chloroacetamide compound, which is Dimethanamid; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In an embodiment, the present invention also provides a stable non-aqueous agrochemical formulation comprising (a) an effective amount of a Triketone herbicide; (b) an effective amount of at least one additional herbicide, wherein the additional herbicide is a Sulfonylamino-carbonyl triazolinone compound, which is Thiencarbazone methyl; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In a specific embodiment, the present invention provides a stable non-aqueous agrochemical formulation comprising (a) an effective amount of Mesotrione; (b) an effective amount of Dimethanamid; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In another specific embodiment, the present invention provides a stable non-aqueous agrochemical formulation comprising (a) an effective amount of Mesotrione; (b) an effective amount of Thiencarbazone methyl; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate.

In an embodiment, the present invention provides a stable non-aqueous agrochemical formulation comprising (a) an effective amount of Mesotrione; (b) an effective amount of Dimethanamid; (c) an effective amount of one or more vegetable oils or derivatives thereof, as solvents; and (d) an effective amount of a surfactant system comprising a mixture comprising Soprophor 3 D33 and Soprophor BSU.

In an embodiment, the present invention provides a stable non-aqueous agrochemical formulation comprising (a) an effective amount of Mesotrione; (b) an effective amount of Thiencarbazone methyl; (c) an effective amount of one or more vegetable oils or derivatives thereof, as solvents; and (d) an effective amount of a surfactant system comprising a mixture comprising Soprophor 3 D33 and Soprophor BSU.

In an embodiment, the present invention provides a stable non-aqueous agrochemical formulation comprising (a) an effective amount of a Triketone herbicide; (b) an effective amount of at least one additional herbicide; (c) an effective amount of one or more vegetable oils or derivatives thereof, as solvents are selected from a group comprising rapeseed oil, soybean oil, olive oil, castor oil, sunflower seed oil, coconut oil, corn oil, cottonseed oil, linseed oil, palm oil, peanut oil, safflower oil, sesame oil, tung oil kapok oil, papaya oil, camellia oil, rice bran oil or the derivatives thereof; and (d) an effective amount of a surfactant system comprising a mixture comprising an ionic phosphated Tristyrylphenol alkoxylate and a non-ionic Tristyrylphenol alkoxylate.

In an embodiment, the present invention provides a stable non-aqueous agrochemical formulation comprising (a) an effective amount of a Triketone herbicide; (b) an effective amount of at least one additional herbicide; (c) an effective amount of the vegetable oil is rapeseed oil, which is a refined canola oil; and (d) an effective amount of a surfactant system comprising a mixture comprising an ionic phosphated Tristyrylphenol alkoxylate and a non-ionic Tristyrylphenol alkoxylate.

In a further embodiment, the present invention provides the said stable non-aqueous agrochemical formulation additionally comprises a safener, wherein the safener is selected from a group comprising Cyprosulfamide and Mefenpyr-diethyl.

In an embodiment, the present invention provides the said stable non-aqueous agrochemical formulation additionally comprises a safener, which is Cyprosulfamide.

In a further embodiment, the present invention provides the said stable non-aqueous agrochemical formulation additionally comprises one or more additives comprising an emulsifier and a thickener.

In an embodiment, the present invention provides the said stable non-aqueous agrochemical formulation additionally comprises emulsifier and a thickener, wherein the emulsifier is polyethylene glycol ester of fatty acid, and the thickener is a silica.

In an embodiment, the present invention provides a method of treating a plant against undesired vegetation comprising applying non-aqueous agrochemical formulation disclosed herein, after dilution with water, to the target sites of the field, so as to treat the plant against undesired vegetation.

In an embodiment, the present invention provides a use of the non-aqueous agrochemical formulation disclosed herein for controlling grassy and broadleaf weeds such as Digitaria ssp., Echinochloa ssp., Setaria ssp., Eriochloa ssp., Sorghum ssp., Lolium ssp., Panicum ssp, Poa ssp, Agropyron ssp, Amaranthus ssp., Abutilon ssp., Ambrosia ssp., Chenopodium SSP., Datura Ssp., Mercurialis ssp., Fallopia ssp., Portulaca ssp., Solanum ssp., Stellaria ssp., Thlaspi ssp, Viola ssp., Geranium ssp, Matricaria ssp, Polygonum ssp, Cirsium ssp, Xanthium ssp and Hibscus ssp on fields, more particularly in corn (maize) field.

In an embodiment, the present invention provides a process for the preparation of the non-aqueous agrochemical formulation disclosed herein from individual component parts.

In an embodiment, the present invention provides a method of controlling undesired vegetation comprising applying to the locus the non-aqueous agrochemical formulation disclosed herein. The present invention also provides a method for controlling grassy and broadleaf weeds comprising diluting with water non-aqueous agrochemical formulation disclosed herein, and applying the formulation to the locus of the plant.

In an embodiment, the present invention provides a method of controlling undesired vegetation comprising applying to the locus the stable non-aqueous agrochemical formulation comprising (a) an effective amount of a Triketone herbicide; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate in a ratio of 1:1 to 10:1.

In an embodiment, the present invention provides a method of controlling undesired vegetation comprising applying to the locus the stable non-aqueous agrochemical formulation comprising (a) an effective amount of Mesotrione; (b) an effective amount of at least one additional herbicide; (c) an effective amount of one or more vegetable oils or derivatives thereof, as solvents; and (d) an effective amount of a surfactant system comprising a mixture comprising an ionic phosphated Tristyrylphenol alkoxylate and a non-ionic Tristyrylphenol alkoxylate in a ratio of 1:1 to 10:1.

The following examples illustrate the practice of the present invention in some of its embodiments but should not be construed as limiting the scope of the invention. Other embodiments will be apparent to one skilled in the art from consideration of the specification and examples. It is intended that the specification, including the examples, is considered exemplary only without limiting the scope and spirit of the invention.

### Preparatory Examples

### Formulation:

Some exemplary embodiments of the formulations of the present invention* along with the comparative formulations # are illustrated in the following tables with their respective Physico-chemical data:

TABLE 1
Recipe: Mesotrione + Thiencarbazone-
methyl + Cyprosulfamide OD

| | | | | example 4 (the |
|---|---|---|---|---|
| | | | | recipe of the |
| | exam- | exam- | exam- | present |
| component | ple 1^{#} | ple 2^{#} | ple 3^{#} | invention*) |
| % Mesotrione (as 100%) | 10 | 10 | 10 | 10 |
| % Thiencarbazone- | 3.5 | 3 | 3 | 3 |
| methyl (TCM) (as | | | | |
| 100%) | | | | |
| % Cyprosulfamide | 5.25 | 4.5 | 4.5 | 4.5 |
| (safener) (as 100%) | | | | |
| % Alkamuls VO 2003 | 15 | 10 | 14 | 16 |
| % Soprophor BSU | none | 2 | 2 | 0.5 |
| % Soprophor 3D33 | none | none | 1 | 1 |
| % Aerosil 200 | 2 | 2 | none | 1.5 |
| % Sipernat 22S | none | none | 3 | none |
| % rapeseed oil | up | up | up | up |
| | to 100% | to 100% | to 100% | to 100% |

relevant results:

| | | | | |
|---|---|---|---|---|
| % Mesotrione | 10 | 7.75 | 4.26 | 1.34 |
| decomposition | | | | |
| (TS 54, 2 W) | | | | |
| % TCM decomposition | 11.8 | 5.34 | 3.15 | 2.25 |
| (TS 54, 2 W) | | | | |
| % Cyprosulfamide | 4 | 3.2 | 3.2 | 1.05 |
| decomposition | | | | |
| (TS 54, 2 W) | | | | |
| dispersion stability (1% | sedi- | sedi- | sediments | No sedi- |
| in water D¹) | ments | ments | (small | ment |
| (TS 54, 2 W²) | | | amount) | |
| % Wet Sieve Residue | 0.1 | 0.171 | <0.01 | <0.01 |
| (WSR) (150 μm) | | | | |
| (TS 54, 2 W²) | | | | |

¹water D = abbreviation of CIPAC (Collaborative International Pesticides Analytical Council) standard water type D, according to method MT 18.
²TS 54, 2 W = abbreviation of accelerated storage test at 54° C. for 2 weeks. CIPAC method MT 46.4

TABLE 2
Recipe: Mesotrione + Dimethanamid OD

| | | | example 3 (the |
|---|---|---|---|
| | | | recipe of the |
| | exam- | exam- | present |
| component | ple 1^{#} | ple 2^{#} | invention*) |
| % Mesotrione tech (as | 9.1 | 9.1 | 4.76 |
| 100%) | | | |
| % Dimethenamid -P | 45.5 | 45.5 | 23.81 |
| tech (as 100%) | | | |
| % Alkamuls VO 2003 | 15 | 10 | 14 |
| % Soprophor BSU | none | 2 | 0.5 |
| % Soprophor 3D33 | none | none | 2 |
| % Aerosil 200 | 1 | 1 | none |
| % Aerosil R 805 | none | none | 2 |
| % rapeseed oil | up to 100% | up to 100% | up to 100% |

relevant results:

| | | | |
|---|---|---|---|
| % Mesotrione | 9.7 | 1.5 | 1.61 |
| decomposition | | | |
| (TS 54, 2 W) | | | |
| % Dimethenamid - | 0.2 | 0.1 | 0.04 |
| P decomposition | | | |
| (TS 54, 2 W) | | | |
| dispersion stability (2% | sediments | sediments | no sediment |
| in water D¹) | | | |
| (TS 54, 2 W) | | | |
| % Wet Sieve Residue | >0.1 | >0.1 | <0.01 |
| (WSR) (150 μm) | | | |
| (TS 54, 2 W²) | | | |

¹water D = abbreviation of CIPAC (Collaborative International Pesticides Analytical Council) standard water type D, according to method MT 18.
²TS 54, 2 W = abbreviation of accelerated storage test at 54° C. for 2 weeks. CIPAC method MT 46.4

It has been found from the data of some exemplary recipes of the present invention, when compared with the other comparative recipes that the formulation of the present application with a surfactant system comprising an ionic phosphated Tristyrylphenol alkoxylate and a non-ionic Tristyrylphenol alkoxylate system exhibited enhanced chemical stability as well as physical stability (e.g. lower WSR) and dispersion stability of the active ingredients compared to the formulations where either of them is absent.

What is claimed is:

1. A non-aqueous agrochemical formulation comprising:
(a) an effective amount of a Triketone herbicide;
(b) an effective amount of at least one additional herbicide;
(c) an effective amount of one or more vegetable oils or derivatives thereof, as solvents; and
(d) an effective amount of a surfactant system comprising a mixture comprising an ionic phosphated Tristyrylphenol alkoxylate and a non-ionic Tristyrylphenol alkoxylate.

2. The non-aqueous agrochemical formulation of claim 1, wherein the surfactant system comprising a mixture comprising an ionic phosphated Tristyrylphenol alkoxylate and a non-ionic Tristyrylphenol alkoxylate in a ratio of 1:1 to 10:1.

3. The non-aqueous agrochemical formulation of any one of claims 1-2, wherein the Triketone herbicide is selected from a group comprising Mesotrione, Sulcotrione, and Tembotrione.

4. The non-aqueous agrochemical formulation of claim 3, wherein the Triketone herbicide is Mesotrione.

5. The non-aqueous agrochemical formulation of claim 1, wherein the additional herbicide is selected from a group comprising a Chloroacetamide and a Sulfonylamino-carbonyl triazolinone compound

6. The non-aqueous agrochemical formulation of claim 5, wherein the additional herbicide is a Chloroacetamide compound, which is Dimethanamid.

7. The non-aqueous agrochemical formulation of claim 5, wherein the additional herbicide is a Sulfonylamino-carbonyl triazolinone compound, which is Thiencarbazone methyl.

8. The non-aqueous agrochemical formulation of claim 1, wherein the surfactant system comprising a mixture comprising Soprophor 3 D33 and Soprophor BSU.

9. The non-aqueous agrochemical formulation of any one of claims 1-7 further comprising a safener, wherein the safener is selected from a group comprising cyprosulfamide and mefenpyr-diethyl.

10. The non-aqueous agrochemical formulation of claim 9, wherein the safener is cyprosulfamide.

11. The non-aqueous agrochemical formulation of any one of claims 1-10 further comprising one or more additives comprising an emulsifier and a thickener.

12. The non-aqueous agrochemical formulation of claim 11, wherein the emulsifier is polyethylene glycol ester of fatty acid, and the thickener is a silica.

13. The non-aqueous agrochemical formulation of any one of claims 1-12, wherein vegetable oils or derivatives thereof, are selected from a group comprising rapeseed oil, soybean oil, olive oil, castor oil, sunflower seed oil, coconut oil, corn oil, cottonseed oil, linseed oil, palm oil, peanut oil, safflower oil, sesame oil, tung oil kapok oil, papaya oil, camellia oil, rice bran oil or derivatives thereof.

14. The non-aqueous agrochemical formulation of claim 13, wherein vegetable oil is a rapeseed oil, which is a refined canola oil.

15. A method of treating a plant against undesired weeds comprising applying herbicide formulation system of any one of claims 1-14, after dilution with water, to the target sites of the field, so as to treat the plant against undesired weeds.

16. The method of claim 15, wherein the undesired weeds are selected from a group comprising grassy and broadleaf weeds.

17. The method of any one of claims 15-16, wherein the undesired weeds are selected from a group comprising Digitaria ssp., Echinochloa ssp., Setaria ssp., Eriochloa ssp., Sorghum ssp., Lolium ssp., Panicum ssp, Poa ssp, Agropyron ssp, Amaranthus ssp., Abutilon ssp., Ambrosia ssp., Chenopodium SSP., Datura Ssp., Mercurialis ssp., Fallopia ssp., Portulaca ssp., Solanum ssp., Stellaria ssp., Thlaspi ssp, Viola ssp., Geranium ssp, Matricaria ssp, Polygonum ssp, Cirsium ssp, Xanthium ssp and Hibscus ssp.
